(19) United States
(12) Patent Application Publication
(10) Pub. No.: US 2024/0364260 A1
(43) Pub. Date: Oct. 31, 2024

(54) VERTICAL AUTONOMOUS SOLAR STREETLIGHT SYSTEM

(71) Applicant: ALAN INGOUVILLE, MIAMI BEACH, FL (US)

(72) Inventor: ALAN INGOUVILLE, MIAMI BEACH, FL (US)

(21) Appl. No.: 18/309,017

(22) Filed: Apr. 28, 2023

(51) Int. Cl. H02S 40/38; F21S 8/08; F21S 9/03; H02S 40/32

(52) U.S. Cl. CPC H02S 40/38; F21S 8/086; F21S 9/035; H02S 40/32; F21W 2131/103

(57) ABSTRACT

A vertical autonomous solar streetlight system. The vertical autonomous solar streetlight system uses a vertical solar array that surrounds the lateral sides of a light pole of the streetlight system to capture the maximum amount of light, while simultaneously providing a gravity induced self-cleaning system, and a low-profile geometry that is aerodynamic. The streetlight system uses a solar array, a controller, an inverter, and a battery, all being operatively connected to power the light of the streetlight system.

### TECHNICAL FIELD

The present invention is directed to a vertical autonomous solar streetlight system.

### BACKGROUND

The present invention was conceived to have an illumination system that can work in severe weather conditions, ie, tropical storms, hurricanes, snowfall, flooding, etc, where conventional streetlights do not run in those conditions and for a long period of time in most cases after the bad weather has gone. At the same time, to have a reliable system that reduce the maintenance that must be performed when operating lights that are powered by the common solar panel system.

Presently, there are streetlights that use a solar power system to power the lights. The streetlights are efficient when first installed, yet as time passes their efficiency is reduced by dirt and animal waste, due to their conventional designs.

The reason that the systems are not efficient is because of the positioning of the solar panels above the housings that hold the lights of the streetlights.

The solar panels that are placed above the housings have a limited efficiency because they run nearly horizontal to the ground in which the streetlights are secured.

The effectiveness of present solar streetlight systems are commonly reduced not only by bird or other animal droppings that accumulate waste over the solar panels through time, but any kind of obstructions to the cells, like dust, snow or tree leaves. As time passes, the efficiency of those common solar panel layouts goes down dramatically until they are manually cleaned, which needs to be often.

The present invention uses a vertical solar array that runs vertically along the pole of a streetlight to maximize the efficiency of this solar streetlight system, while simultaneously creating a gravity induced self-cleaning system, due to the solar streetlight systems unique design.

The present invention addresses the need of having a solar powered streetlight system that is highly efficient and ecological.

### SUMMARY

The present invention is directed to a vertical autonomous solar streetlight system. The vertical autonomous solar streetlight system uses a vertical solar array that surrounds the pole of the streetlight to capture the maximum amount of light, while simultaneously providing a gravity induced self-cleaning system that is wind resistant. The vertical autonomous solar streetlight system uses a solar array, a controller, an inverter, and a battery, all being operatively connected to power the light of the solar streetlight system.

An object of the present invention is to provide an autonomous solar streetlight system that requires next to zero maintenance that can withstand many types of weather conditions.

Another object of the present invention is to provide an autonomous solar streetlight system that can have maximum efficiency to capture solar energy.

Yet another object of the present invention is to provide an autonomous solar streetlight system that can produce enough energy to operate continuously for a prolonged period with no intermittences.

Yet still another object of the present invention is to provide an autonomous solar streetlight system that will capture part of its own residual energy.

A further object of the present invention is to provide an autonomous solar streetlight system that will not be affected by snowfall, flood conditions, animal waste, dirt, etc.

Yet a further object of the present invention is to provide an autonomous solar streetlight system whose shape is resistant to wind due to the vertical geometry and the low profile of its unique design.

### BRIEF DESCRIPTION OF THE DRAWINGS

These and other features, aspects, and advantages of the present invention will become better understood with regards to the following description, appended claims, and drawings where:

FIG. 1 is a top view of the present invention;

FIG. 2 is a front view of the present invention;

FIG. 3 is a side view of the present invention; and

FIG. 4 is a perspective view of the present invention.

### DESCRIPTION

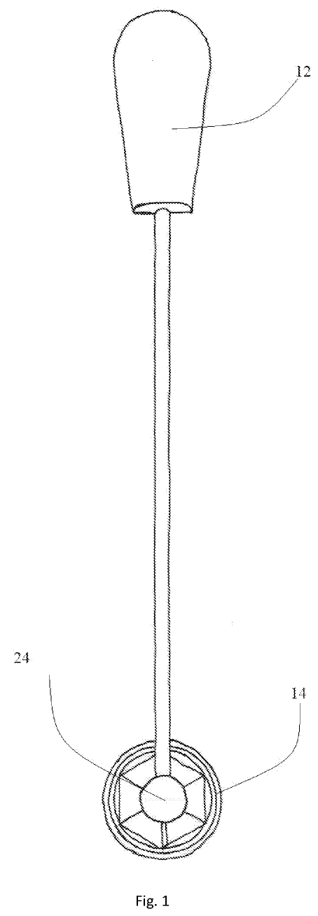

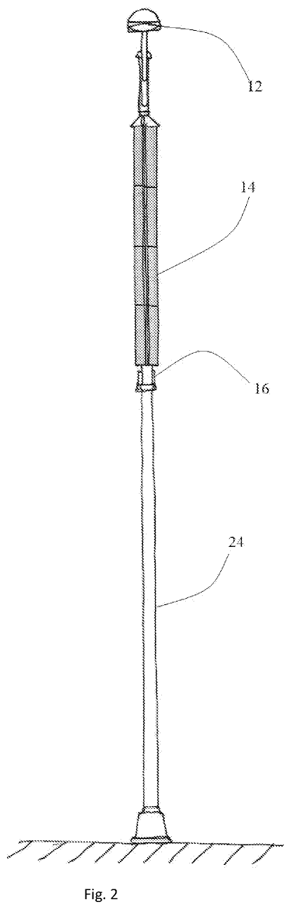

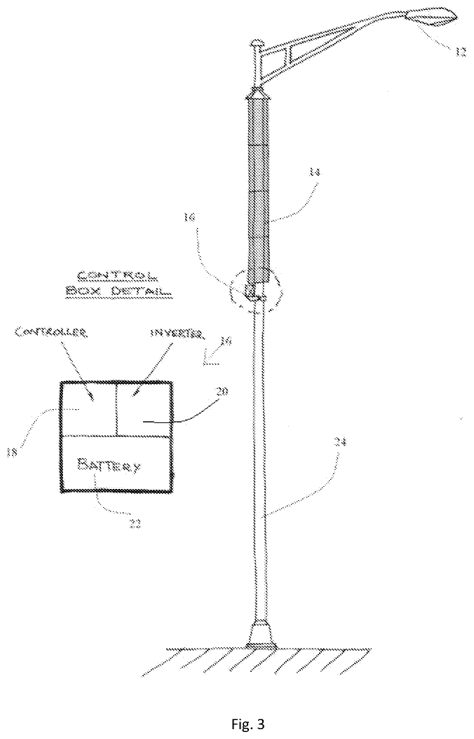

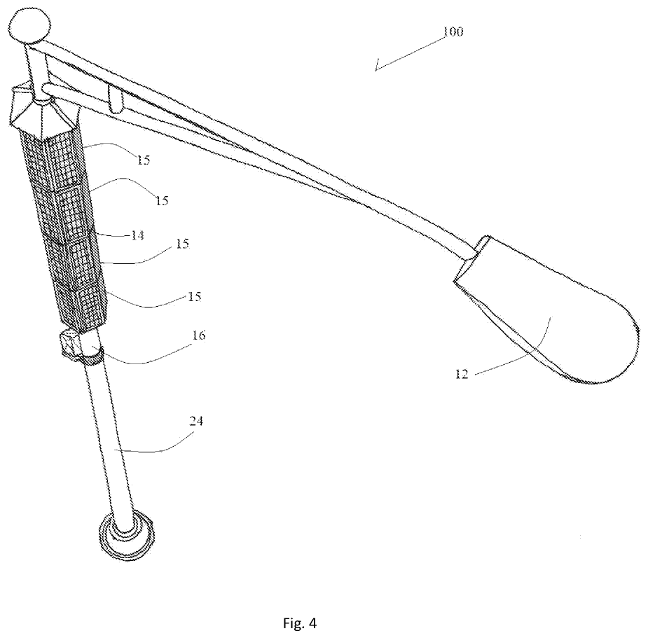

As seen in FIGS. 1-4, the present invention is a vertical autonomous solar streetlight system 100.

The vertical autonomous solar streetlight system 100 comprises of a light pole 24. A light 12 that is horizontally attached to the light pole 24. A solar array 14 that is vertically attached to the light pole 24 so that any lateral side of the light pole 24 is covered by the solar array 14. A housing 16 that is attached to the light pole 24. An inverter 20 that is housed in the housing 16. And, a controller 18 that is housed in the housing 16, the controller 18 is operative connected to the solar array 14, to the inverter 20, and to a battery 22 that is housed in the housing 16, the battery 22 is operatively connected to the inverter 20, and wherein the battery 22, the controller 18, and the inverter 20 are operatively connected to the light 12.

In all embodiments of the present invention, the solar array 14 is comprised of a plurality of solar panels 15 that are connected in parallel to each other. The solar panels 15 being connected in parallel prevents the system from universally malfunctioning due to shadows or a any other obstruction that may affect a particular solar panel 15 of the solar array 14.

The present invention comprises of a vertical modular streetlight system of a solar array of at least six solar panels per module, generating a structure of between eighteen (Three modules) to twenty-four panels (four modules) growing modularly according to the specific energy need required.

In still yet another embodiment, the solar array 14 is comprised of eighteen solar panels 15 that are connected in parallel.

In yet still yet another embodiment, the solar array 14 is comprised of twenty-four solar panels 15 that are connected in parallel.

In another embodiment of the present invention, the battery 22 is a lithium battery.

The present invention is designed to provide two days of backup power due to its relationship between the power it generates, the energy capacity it stores, and the energy consumption that the light consumes.

The solar array of the present invention is designed to collect from 450 Wh to 720 Wh of energy, or more, depending on the number of modules configuration.

The present inventions placement of the solar array and the housing that holds its charge make it an ideal streetlight system during extreme weather conditions, for the streetlights do not have to be shut-off during the extreme weather conditions.

In a preferred embodiment of the present invention, the solar panels will be arranged as a solar array of six vertical faces of solar panels around the light pole. The vertical placement of the solar panels around the light pole allows gravity to have any waste that lands on the solar panels to flow downward and not to stay stagnant on the faces of the solar panels. The placement of the solar panels around the light pole also allows the solar array to capture light from all angles around the light pole, while also being highly resistant to strong winds due to its low profile, its aerodynamic shape.

An advantage of the present invention is that it provides an autonomous solar streetlight that requires next to zero maintenance.

Another advantage of the present invention is that it provides an autonomous solar streetlight that has a maximum efficiency to capture solar energy.

Yet another advantage of the present invention is that it provides an autonomous solar streetlight that produces enough energy to operate continuously for prolonged periods.

Yet still another advantage of the present invention is that it provides an autonomous solar streetlight that captures part of its own residual energy.

A further advantage of the present invention is that it provides an autonomous solar streetlight that is not affected by snowfall.

Yet a further advantage of the present invention is that it provides an autonomous solar streetlight that is aerodynamic.

The embodiments of the vertical autonomous solar streetlight system described herein are exemplary and numerous modifications, combinations, variations, and rearrangements can be readily envisioned to achieve an equivalent result, all of which are intended to be embraced within the scope of the appended claims. Further, nothing in the above-provided discussions of the vertical autonomous solar streetlight system should be construed as limiting the invention to an embodiment or a combination of embodiments. The scope of the invention is defined by the description, drawings, and claims.

1. A vertical autonomous solar streetlight system, the vertical autonomous solar streetlight system comprises:
a light pole;
a light that is horizontally attached to the light pole;
a solar array that surrounds the light pole, the solar array is vertically attached to the light pole;
an inverter that is housed in the housing; and
a controller that is housed in the housing, the controller is operative connected to the solar array, to the inverter, and to a battery that is housed in the housing, wherein the inverter is connected to the light, the controller manages the DC energy that goes to the battery, the controller also sends DC energy to the inverter that transforms the DC energy from the battery to AC energy that powers the light.

2. The vertical autonomous solar streetlight system of claim 1, wherein the solar array is comprised of a plurality of solar panels that are connected in parallel to each other.

3. The vertical autonomous solar streetlight system of claim 2, wherein the solar array produces between at least 450 Wh up to 720 Wh of energy

4. The vertical autonomous solar streetlight system of claim 3, wherein the battery is a lithium battery.

5. The vertical autonomous solar streetlight system of claim 1, wherein the solar array is comprised of eighteen solar panels that are connected in parallel.

6. The vertical autonomous solar streetlight system of claim 1, wherein the solar array is comprised of twenty-four solar panels that are connected in parallel.
